(19) United States
(12) Patent Application Publication
(10) Pub. No.: US 2026/0044050 A1
(43) Pub. Date: Feb. 12, 2026

(54) CAMERA LENS-SHIFT BALL BEARING VOICE COIL MOTOR ACTUATORS WITH FLAT COILS

(71) Applicant: Apple Inc., Cupertino, CA (US)

(72) Inventors: Andrew S Jozefov, San Francisco, CA (US); Alfred N Mireault, San Francisco, CA (US); Scott W Miller, Los Gatos, CA (US)

(73) Assignee: Apple Inc., Cupertino, CA (US)

(21) Appl. No.: 19/288,392

(22) Filed: Aug. 1, 2025

Related U.S. Application Data
(60) Provisional application No. 63/682,309, filed on Aug. 12, 2024.

(51) Int. Cl. G03B 5/00; G02B 27/64; G03B 13/36; H04N 23/52; H04N 23/54; H04N 23/55; H04N 23/68

(52) U.S. Cl. CPC G03B 5/00; G02B 27/646; G03B 13/36; H04N 23/52; H04N 23/54; H04N 23/55; H04N 23/6812; H04N 23/687; G03B 2205/0015; G03B 2205/0069

(57) ABSTRACT

An actuator assembly for a camera includes a plurality of carriers each configured to allow movement of an optical assembly along respective axes of the optical axis, a first axis orthogonal to the optical axis, and a second axis orthogonal to the first axis and the optical axis. Ball bearings for the carriers allow for movement along the axes. Actuators move the optical assembly, via the respective carriers, along the axes in response to receiving electrical current. Coils of at least two actuators for movement of the optical assembly along at least two axes face in a direction parallel to the optical axis. Gaps between magnets and associated coils of at least two actuators for movement of the optical assembly along at least two axes remain constant during movement of the optical assembly along each of the optical axis, the first axis, and the second axis.

### PRIORITY CLAIM

The present application claims priority to U.S. Provisional Appl. No. 63/682,309, filed Aug. 12, 2024, which is incorporated by reference herein in its entirety.

### BACKGROUND

### Technical Field

This disclosure relates generally to a lens-shift ball bearing camera actuator having voice coil motor (VCM) optical image stabilization (OIS) coils in arranged in a flat orientation.

### Description of the Related Art

The advent of small, mobile multipurpose devices such as smartphones and tablet or pad devices has resulted in a need for high-resolution, small form factor cameras for integration in the devices. Some cameras may incorporate an autofocus (AF) mechanism whereby the object focal distance can be adjusted to focus an object plane in front of the camera at an image plane to be captured by the image sensor. Further, some cameras may incorporate optical image stabilization (OIS) mechanisms that may sense and react to external excitation/disturbance by adjusting location of the optical lens on the X and/or Y axis in an attempt to compensate for unwanted motion of the lens.

### BRIEF DESCRIPTION OF THE DRAWINGS

FIG. 1 illustrates components of an example camera having an actuator module or assembly that may, for example, be used to provide autofocus (AF) and optical image stabilization (OIS) through lens movement in small form factor cameras, according to at least some embodiments. FIG. 1 shows an overhead view of the exterior of the camera.

FIG. 2 illustrates components of an example camera having an actuator module or assembly that may, for example, be used to provide AF and OIS through lens movement in small form factor cameras, according to at least some embodiments. FIG. 2 shows a cross-sectional view of the camera.

FIG. 3 illustrates components of an example actuator module or assembly that may, for example, be used to provide AF and OIS through lens movement in small form factor cameras, according to at least some embodiments. FIG. 3 shows a perspective view of the actuator module or assembly.

FIG. 4 illustrates components of an example actuator assembly base of an actuator module or assembly that may, for example, be used to provide AF and OIS through lens movement in small form factor cameras, according to at least some embodiments. FIG. 4 shows a perspective view of an actuator assembly base of an actuator module or assembly.

FIG. 5 illustrates components of an example actuator assembly base and a first OIS carrier of an actuator module or assembly that may, for example, be used to provide AF and OIS through lens movement in small form factor cameras, according to at least some embodiments. FIG. 5 shows a perspective view of an actuator assembly base and a first OIS carrier of an actuator module or assembly.

FIG. 6 illustrates components of an example actuator assembly base, a first OIS carrier, and a second OIS carrier of an actuator module or assembly that may, for example, be used to provide AF and OIS through lens movement in small form factor cameras, according to at least some embodiments. FIG. 6 shows a perspective view of an actuator assembly base, a first OIS carrier, and a second OIS carrier of an actuator module or assembly.

FIG. 7 illustrates components of an example actuator assembly base, a first OIS carrier, a second OIS carrier, and an AF carrier of an actuator module or assembly that may, for example, be used to provide AF and OIS through lens movement in small form factor cameras, according to at least some embodiments. FIG. 7 shows a perspective view of an actuator assembly base, a first OIS carrier, a second OIS carrier, and an AF carrier of an actuator module or assembly.

FIG. 8 illustrates components of an example actuator module or assembly that may, for example, be used to provide AF and OIS through lens movement in small form factor cameras, according to at least some embodiments. FIG. 8 shows an exploded view of the actuator module or assembly.

FIGS. 9 and 10 illustrate components of other example actuator modules or assemblies that may, for example, be used to provide AF and OIS through lens movement in small form factor cameras, according to at least some embodiments. FIG. 9 shows an exploded view of another actuator module or assembly. FIG. 10 shows an exploded view of yet another actuator module or assembly.

FIG. 11 illustrates a schematic representation of an example device that may include a camera, in accordance with some embodiments.

FIG. 12 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Various embodiments described herein relate to an actuator module or assembly that may be used in a camera with a moveable optical assembly. In some examples, the camera may include camera equipment outfitted with controls, magnets, and voice coil motors to improve the effectiveness of a miniature actuation mechanism for a compact camera module. More specifically, in some embodiments, compact camera modules include actuators to deliver functions such as autofocus (AF) and optical image stabilization (OIS). One approach to delivering a very compact actuator assembly is to provide AF and OIS actuators for movement and/or shift of the optical assembly.

Compact cameras (e.g., camera modules) may be used across a variety of mobile devices from cell phones to AR/VR devices. Many cameras may implement AF actuators in order to improve focus performance and support lower F-numbers and OIS actuators to compensate for shaking and movement of the camera. In some applications, a camera actuator assembly may include a plurality of carriers, ball bearings, and associated actuators to move an optical assembly in the x, y, and/or z directions. In many cases, the actuator assembly may include in a direction from an image sensor to the optical assembly along the optical axis, for example: a base, an AF carrier positioned on the base, a first OIS carrier positioned on and/or over the AF carrier, and a second OIS carrier attached to the optical assembly and positioned on and/or over the first OIS carrier, the AF carrier, and/or the base.

With these configurations, the various carriers house or include fixedly attached magnets while the stationary base houses or includes stationary coils to align with respective magnets for voice coil motor (VCM) actuators. For example, a first magnet attached to the AF carrier may align with a coil on a first wall of the base such that when the coil receives an electrical current, the AF carrier due to the magnet may experience Lorenze forces that move the AF carrier, the first OIS carrier, the second OIS carrier, and the optical assembly along the optical axis, via ball bearings, for AF. In other words, with the AF carrier positioned below the first OIS carrier, the second OIS carrier, and the optical assembly, both the first OIS carrier and the second OIS carrier may move along the optical axis when the AF carrier moves along the optical axis to produce AF movement of the optical assembly. A second magnet attached to the second OIS carrier may align with a coil on a second wall of the base, adjacent the first wall, such that when that coil receives an electrical current, the second OIS carrier due to the magnet may experience Lorenze forces that move the first OIS carrier, the second OIS carrier, and the optical assembly along a first axis orthogonal to the optical axis, via ball bearings, for OIS stabilization (e.g., in the x-direction or the y-direction). In other words, with the first OIS carrier positioned below the second OIS carrier and the optical assembly, both the first OIS carrier and the second OIS carrier may move along the first axis when the first OIS carrier moves along the first axis to produce OIS movement of the optical assembly (e.g., in the x-direction, or the y-direction). In addition, a third magnet attached to the second OIS carrier may align with another coil on a third wall of the base, adjacent the second wall and across from first wall, such that when that coil receives an electrical current, the second OIS carrier due to the magnet may experience Lorenze forces that move the second OIS carrier and the optical assembly along a second axis orthogonal to the first axis and the optical axis, via ball bearings, for OIS stabilization (e.g., in the y-direction or the x-direction). In other words, with the second OIS carrier and the optical assembly positioned above the first OIS carrier, only the second OIS carrier may move along the second axis to produce OIS movement of the optical assembly (e.g., in the y-direction, or the x-direction).

However, because of the relative positioning of the carriers and the positions of the magnets and coils relative to each other and the carriers, air gaps or distances between magnets and associated coils may change for at least two of the actuators. In other words, at least two air gaps of a first air gap between the magnet and coil for AF movement of the optical assembly, a second air gap between the magnets and coils for OIS movement of the optical assembly along the first axis, or a third air gap between the magnets and coils for OIS movement of the optical assembly along the second axis may vary in distance. For example, because the AF carrier does not move for OIS motion along either of the first axis or the second axis, the magnet included with the AF carrier and the coil on the first wall of the base maintains a constant air gap for AF actuation. However, because the second carrier includes magnets for OIS movement of the optical assembly along the first axis and the second axis and because the coils for OIS movement of the optical assembly are stationary on the walls of the base, an air gap distance between a first coil and magnet pair for OIS movement of the optical assembly along the first axis changes with OIS movement of the optical assembly along the second axis and an air gap distance between a second coil and magnet pair for OIS movement of the optical assembly along the second axis changes with OIS movement of the optical assembly along the first axis.

Actuators with variable air gaps between magnet and coil pairs introduce several issues. For example, when a variable distance air gap is relatively larger, additional power, via electric current through the coil of the magnet and coil pair, may be needed in order to maintain control of the movement of the optical assembly produce by the Lorentz forces from the magnet and coil pair. Similarly, when a variable distance air gap is relatively larger and no additional power, via electric current through the coil of the magnet and coil pair, is available, then the actuator may be unable to maintain control of the movement of the optical assembly using the Lorentz forces from the magnet and coil pair.

Conversely, actuator modules or assemblies with magnet and coil pairs having constant air gaps allow for constant power, via electric current through the coil of the magnet and coil pair, for maintaining control of the movement of the optical assembly produce by the Lorentz forces from the magnet and coil pair through an entire stroke range. Similarly, when actuator modules or assemblies with magnet and coil pairs having constant air gaps have no additional power, via electric current through the coil of the magnet and coil pair, that is available, then the actuator still may be able to maintain control of the movement of the optical assembly using the Lorentz forces from the magnet and coil pair through an entire stroke range.

As describe herein, a camera with an actuator module or assembly is provided having a plurality of carriers that utilize ball bearings and VCM AF and OIS actuators for AF and OIS movement of the optical assembly. The actuator assembly may include flat OIS coils and magnet and coil pairs with constant air gaps for at least two of AF movement of the optical assembly, OIS movement of the optical assembly along the first axis, and OIS movement of the optical assembly along the second axis. For instance, the actuator assembly may include a base with both a first OIS coil for OIS movement of the optical assembly along the first axis and a second OIS coil for OIS movement of the optical assembly along the second axis. The first OIS coil may be positioned on a first seat or arm of the base and the second OIS coil may be positioned on a second seat or arm of the base that is adjacent the first arm. Each of the first OIS coil and the second OIS coil may be positioned flat against the respective first arm and second arm of the base. For example, each of the first OIS coil and the second OIS may sit on the first arm and the second arm, respectively, of the base so that a broader surface of each of the first OIS coil and the second OIS coil face in a direction parallel to the optical axis or in a direction orthogonal to a light receiving surface of the image sensor.

In addition, the actuator module or assembly may include at least one OIS carrier that is positioned between the base and the AF carrier. For instance, the actuator assembly may include in a direction from an image sensor to the optical assembly along the optical axis: a base, a first OIS carrier positioned on and/or over the base, an AF carrier positioned on and/or over the first OIS carrier and the base, and a second OIS carrier attached to the optical assembly and positioned on and/or over the AF carrier, the first OIS carrier, and the base. As described herein, this configuration may allow air gaps between at least two magnet and coil pairs of a first OIS magnet and coil pair, a second OIS magnet and coil pair, and an AF magnet and coil pair to remain constant with movement of the optical assembly along each of the optical axis, the first axis, and the second axis. As another example, the actuator assembly may include in a direction from an image sensor to the optical assembly along the optical axis: a base, a first OIS carrier positioned on and/or over the base, a second OIS carrier positioned on and/or over the first OIS carrier and the base, and an AF carrier attached to the optical assembly and positioned on and/or over the second OIS carrier, the first OIS carrier, and the base. As described herein, this configuration may allow air gaps between all three magnet and coil pairs of the first OIS magnet and coil pair, the second OIS magnet and coil pair, and the AF magnet and coil pair to remain constant with movement of the optical assembly along each of the optical axis, the first axis, and the second axis.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

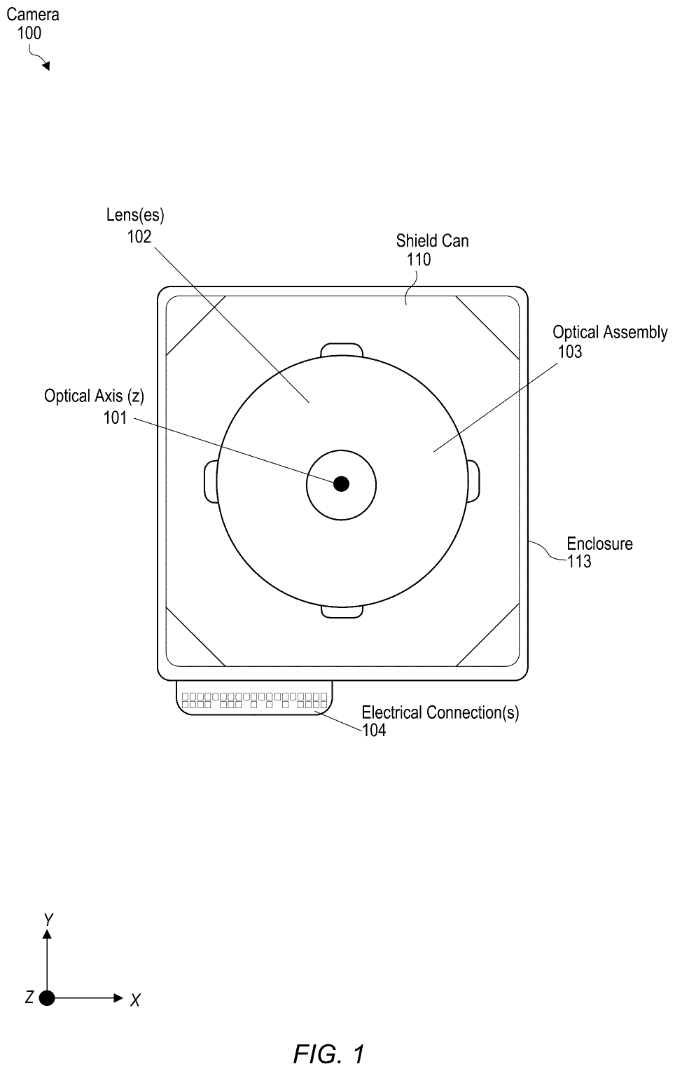

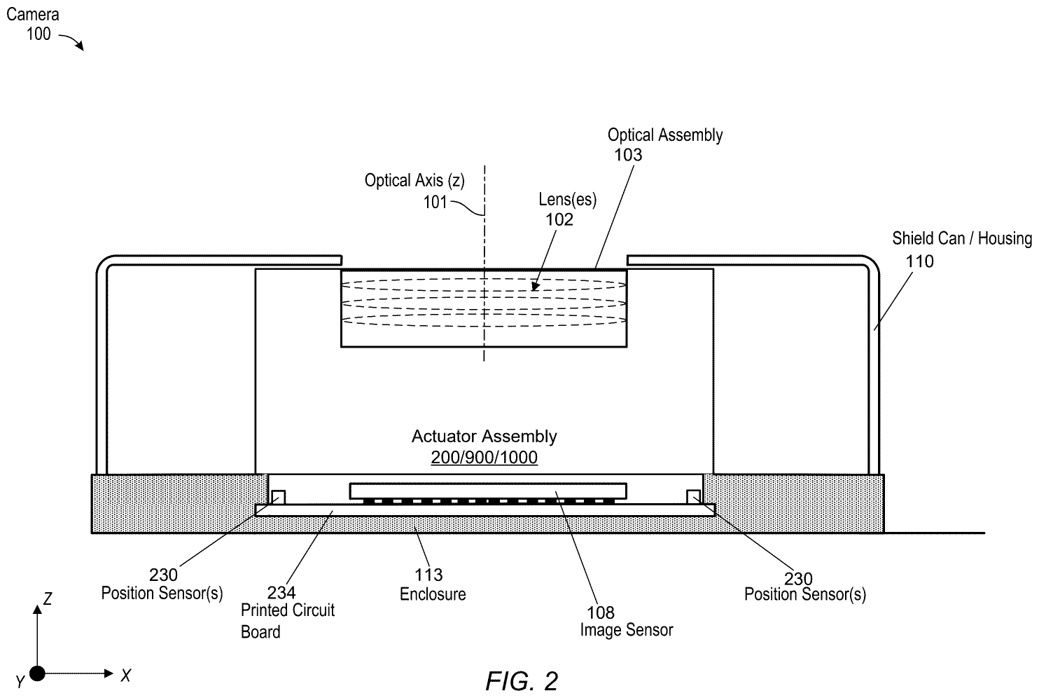

FIG. 1 illustrates components of an example camera 100 having an actuator module or assembly that may, for example, be used to provide autofocus (AF) and optical image stabilization (OIS) through lens movement in small form factor cameras, according to at least some embodiments. FIG. 1 shows an overhead view of the exterior of the camera 100. The camera 100 may include one or more same or similar features as the features described with respect to or illustrated in FIGS. 2, 3, 4, 5, 6, 7, 8, 9, 10, 11, and 12. The example X-Y-Z coordinate system shown in FIG. 1 may be used to discuss aspects of components and/or systems, and may apply to embodiments described throughout this disclosure.

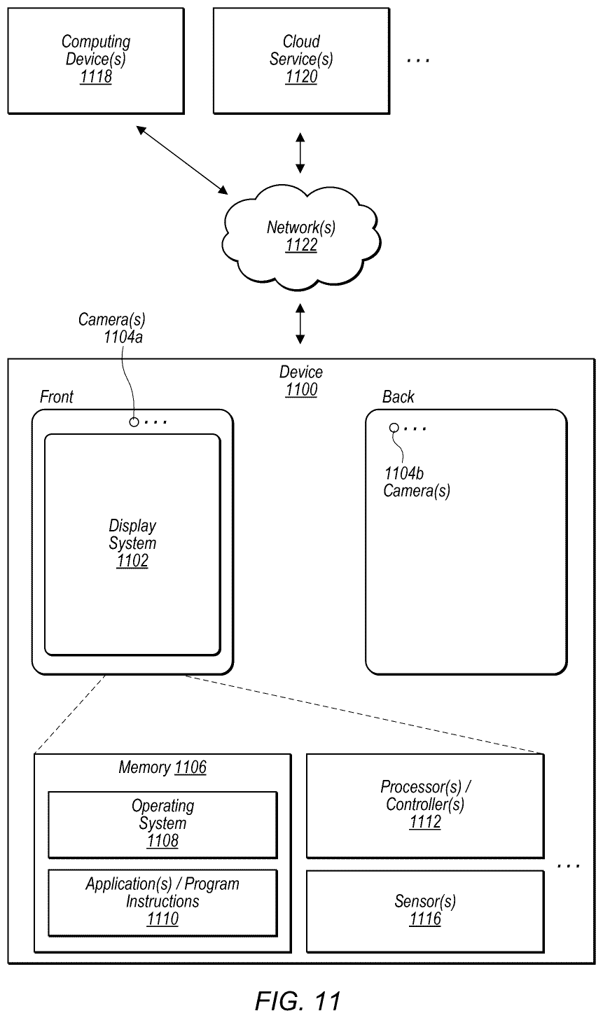

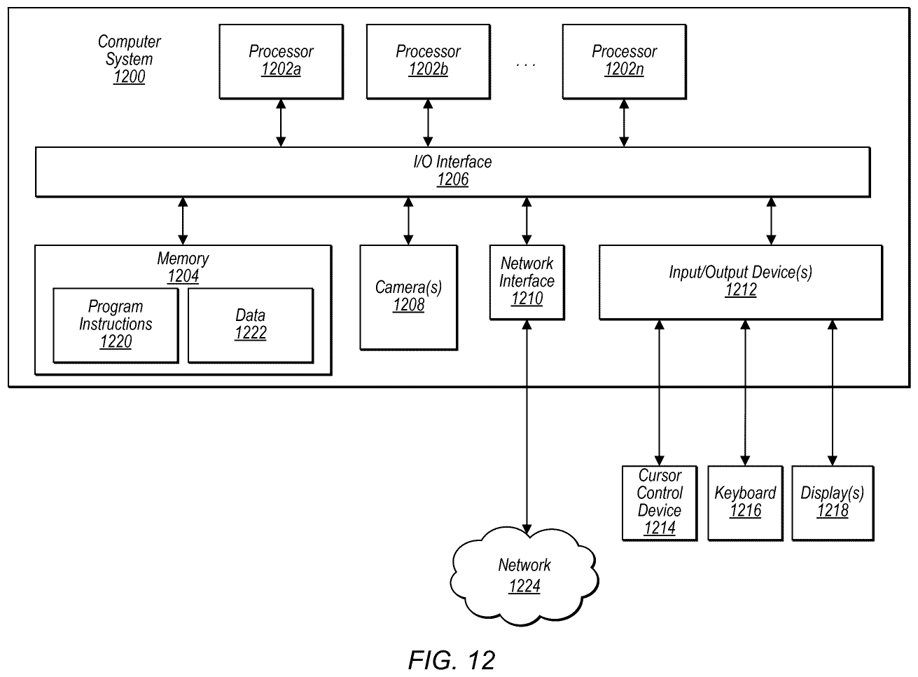

In various embodiments, the camera 100 may include an optical assembly 103 having one or more lenses 102 defining an optical axis (z) 101, a shield can 110, an enclosure 113, and electrical connection(s) 104. The shield can 110 may form an outer wall of a top portion (and in some cases side portions) of the camera 100 and form one or more camera shoulders. The enclosure 113 may form an outer wall of a bottom portion of the camera 100. The electrical connection(s) 104 may extend from the enclosure 113 (and shield can 110) and may electrically connect the camera 100 to an external device. For example, the camera 100 may be the same or similar camera as the camera 1104b illustrated in FIG. 11 or the camera 1208 illustrated in FIG. 12. As such, the electrical connection(s) 104 may extend from the enclosure 113 and may electrically connected the camera 100 to the device 1100 illustrated in FIG. 11 or the computer system 1200 illustrated in FIG. 12, respectively. In some aspects, the shield can 110 may be mechanically coupled to a base via the enclosure 113 attached to both the shield can 110 and the base. As describe herein, the camera 100 may include AF and OIS of the optical assembly.

FIG. 2 illustrates components of an example camera 100 having an actuator module or assembly that may, for example, be used to provide AF and OIS through lens movement in small form factor cameras, according to at least some embodiments. FIG. 2 shows a cross-sectional view of the camera 100. The camera 100 may include one or more same or similar features as the features described with respect to or illustrated in FIGS. 1, 3, 4, 5, 6, 7, 8, 9, 10, 11, and 12. The example X-Y-Z coordinate system shown in FIG. 2 may be used to discuss aspects of components and/or systems, and may apply to embodiments described throughout this disclosure.

As shown in FIG. 2, the camera 100 may include an optical assembly 103 including one or more lenses 102 centered on an optical axis (z) 101, a shield can 110, a printed circuit board (or a substrate) 234, an image sensor 108, a plurality of position sensors 230, the enclosure 113, and the actuator assembly 200/900/1000. The shield can 110 coupled to the enclosure 113 may contain the actuator assembly 200/900/1000, the printed circuit board 234, the image sensor 108, and the plurality of position sensors 230. The actuator assembly 200/900/1000 may be attached to the optical assembly 103 for moving the optical assembly 103 for moving the optical assembly for AF and OIS, as described herein.

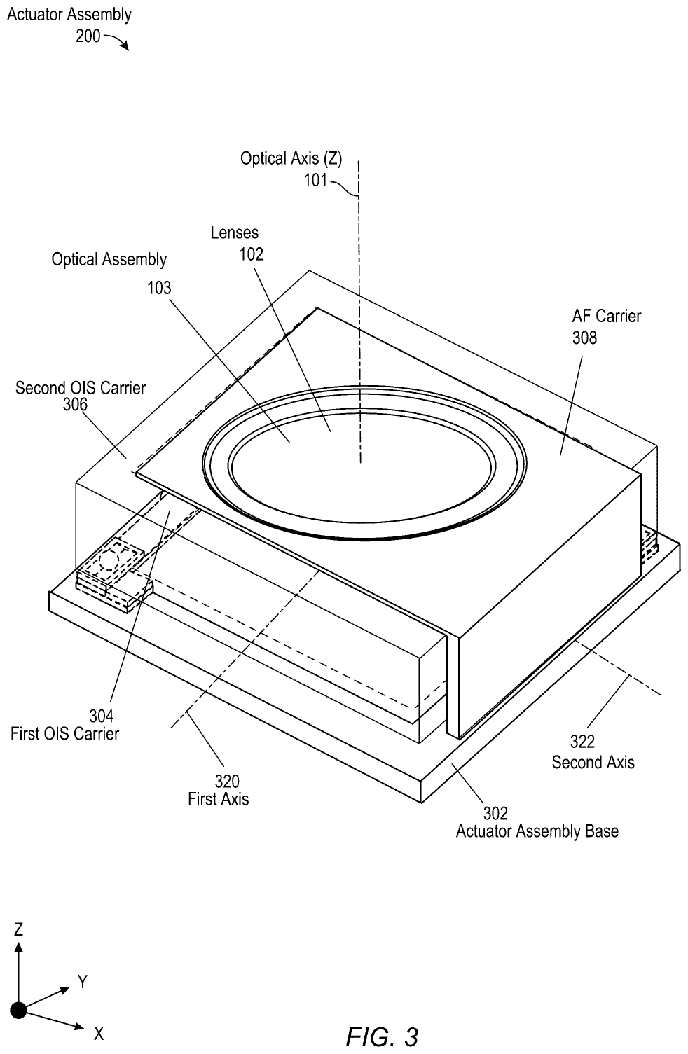

FIG. 3 illustrates components of an example actuator module or assembly 200 that may, for example, be used to provide AF and OIS through lens movement in small form factor cameras, according to at least some embodiments. FIG. 3 shows a perspective view of the actuator module or assembly 200. The actuator assembly 200 may include one or more same or similar features as the features described with respect to or illustrated in FIGS. 1, 2, 4, 5, 6, 7, 8, 9, 10, 11, and 12. The example X-Y-Z coordinate system shown in FIG. 3 may be used to discuss aspects of components and/or systems, and may apply to embodiments described throughout this disclosure.

As shown in FIG. 3, the actuator assembly 200 includes an actuator base 302, and a plurality of carriers including a first OIS carrier 304, a second OIS carrier 306, and an AF carrier 308. The first OIS carrier 304, the second OIS carrier 306, and the AF carrier 308 may form a vertical carrier stack such AF carrier 308 may be stacked on and/or above the second OIS carrier 306, the second OIS carrier 306 may be stacked on and/or above the first OIS carrier 304, and the first OIS carrier 304 may be positioned below both the AF carrier 308 and the second OIS carrier 306. The optical assembly 103 may be fixedly attached to the AF carrier 308.

Also, as shown in FIG. 3, the first OIS carrier 304 may be positioned on the actuator assembly base 302. As such, when an image sensor (e.g., the image sensor 108 of FIG. 2) is position below the actuator assembly base 302 on an opposite side of the actuator assembly base 302 from the optical assembly 103, the vertical stack of carriers may be arranged from the image sensor to the optical assembly 103 in an order as follows: the actuator assembly base 302, the first OIS carrier 304, the second OIS carrier 306, and the AF carrier 308. Positioning at least one of the first OIS carrier 304 or the second OIS carrier 306 between the AF carrier 308 and the actuator assembly base 302 may allow for air gaps between at least two magnet and coil pairs of the actuator assembly 200 to remain constant through each of AF movement of the optical assembly 103, OIS movement of the optical assembly 103 along the first axis, and OIS movement of the optical assembly 103 along the second axis. As shown further herein, positioning both the first OIS carrier 304 and the second OIS carrier 306 between the AF carrier 308 and the actuator assembly base 302 may allow for air gaps between all three magnet and coil pairs of the actuator assembly 200 to remain constant through each of AF movement of the optical assembly 103, OIS movement of the optical assembly 103 along the first axis, and OIS movement of the optical assembly 103 along the second axis.

The actuator assembly base 302 may be static relative to first OIS carrier 304, the second OIS carrier 306, and the AF carrier 308. The actuator assembly base 302 may also include ball bearings that engage and move within tracks formed on an object side of the actuator assembly base 302 and an image side of the first OIS carrier 304. As such, the ball bearings of the actuator assembly base 302 and the tracks formed on the object side of the actuator assembly base 302 and the image side of the first OIS carrier 304 may allow the first OIS carrier 304, the second OIS carrier 306, and the AF carrier 308 to move along first axis 320 (e.g., orthogonal to the optical axis 101) for OIS movement of the optical assembly 103. Further, the first OIS carrier 304 may include ball bearings that engage and move within tracks formed on an object side of the first OIS carrier 304 and on an image side of the second OIS carrier 306. As such, the ball bearing of the first OIS carrier 304 and the tracks formed on the object side of the first OIS carrier 304 and on the image side of the second OIS carrier 306 may allow the second OIS carrier 306 and the AF carrier 308 to move independently of the first OIS carrier 304 and along the second axis 322 (e.g., orthogonal to the optical axis 101 and the first axis 320) for OIS movement of the optical assembly 103. In addition, the second OIS carrier 306 may include ball bearings that engage and move within tracks formed on a side of the second OIS carrier 306 and on overhang wall of the AF carrier 308. As such, the ball bearing of the second OIS carrier 306 and the tracks formed on a side of the second OIS carrier 306 and on overhang wall of the AF carrier 308 may allow the AF carrier 308 to move independently of the first OIS carrier 304 and the second OIS carrier 306 and along the optical axis 101 for AF movement of the optical assembly 103.

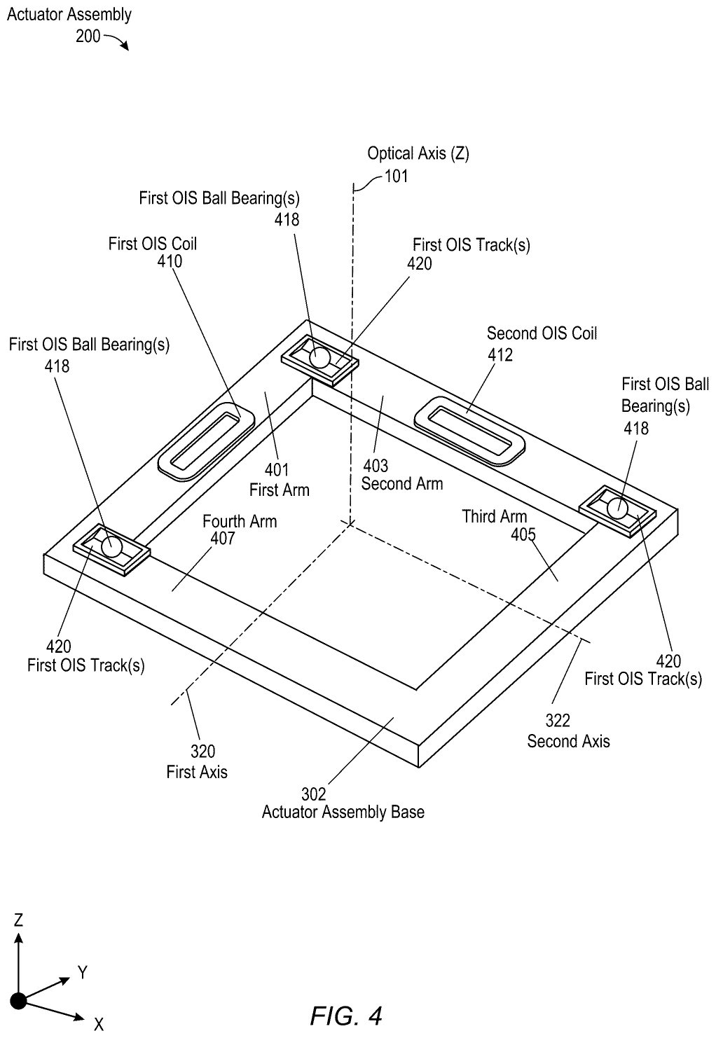

FIG. 4 illustrates components of an example actuator assembly base 302 of an actuator module or assembly 200 that may, for example, be used to provide AF and OIS through lens movement in small form factor cameras, according to at least some embodiments. FIG. 4 shows a perspective view of an actuator assembly base 302 of an actuator module or assembly 200. The actuator assembly base 302 and the actuator assembly 200 may include one or more same or similar features as the features described with respect to or illustrated in FIGS. 1, 2, 3, 5, 6, 7, 8, 9, 10, 11, and 12. The example X-Y-Z coordinate system shown in FIG. 4 may be used to discuss aspects of components and/or systems, and may apply to embodiments described throughout this disclosure.

As shown in FIG. 4, the actuator assembly base 302 may include a first arm 401, a second arm 403 that is adjacent the first arm 401, a third arm 405 that is adjacent the second arm 403 and opposite the first arm 401, and a fourth arm 407 that is adjacent the third arm 405 and the first arm 401 and opposite the second arm 403. First OIS ball bearings 418 and respective first OIS tracks 420 are positioned on an object side of the in at least three of the corners of wear the first arm 401, the second arm 403, the third arm 405, and the fourth arm 407 meet. As described herein, the first OIS ball bearings 418 and the respective first tracks 420 (and also formed on an image side of the first OIS carrier 304) may allow the first OIS carrier 304, the second OIS carrier 306, and the AF carrier 308 to move the optical assembly 103 along the first axis 320 (e.g., in the x-direction or alternatively in the y-direction). The actuator assembly base 302 may also include a first OIS coil 410 positioned on the first arm 401 and a second OIS coil 412 positioned on the second arm 403. As described further herein, the first OIS coil 410 positioned on the first arm 401 may be vertically aligned (e.g., along an axis parallel to the optical axis 101) with a first OIS magnet fixedly attached the second OIS carrier 306. Similarly, the second OIS coil 412 positioned on the second arm 403 may be vertically aligned (e.g., along an axis parallel to the optical axis 101) with a second OIS magnet fixedly attached the second OIS carrier 306. The first OIS coil 410 together with the first OIS magnet may be used to move the first OIS carrier 304, the second OIS carrier 306, and the AF carrier 308 along the first axis 320 for OIS movement of the optical assembly 103 in, for example, the y-direction. Similarly, the second OIS coil 412 together with the second OIS magnet may be used to move the second OIS carrier 306 and the AF carrier 308 along the second axis 322 for OIS movement of the optical assembly 103 in, for example, the x-direction.

Also, as shown in FIG. 4, the first OIS coil 410 and the second OIS coil 412 may be positioned in a flat orientation on the first arm 401 of the actuator assembly base 302 and on the second arm 403 of the actuator assembly base 302, respectively. In other words, a broader side or a side with the greatest surface area of each of the first OIS coil 410 and the second OIS coil 412 may face in a direction parallel to the optical axis 101 and/or in a direction perpendicular to the surface of an image sensor (e.g., image sensor 108 illustrated in FIG. 2) for creating strong Lorentz forces with the first OIS magnet and the second OIS magnet, respectively, to control OIS movement of the optical assembly 103 along the first axis 320 and the second axis 322.

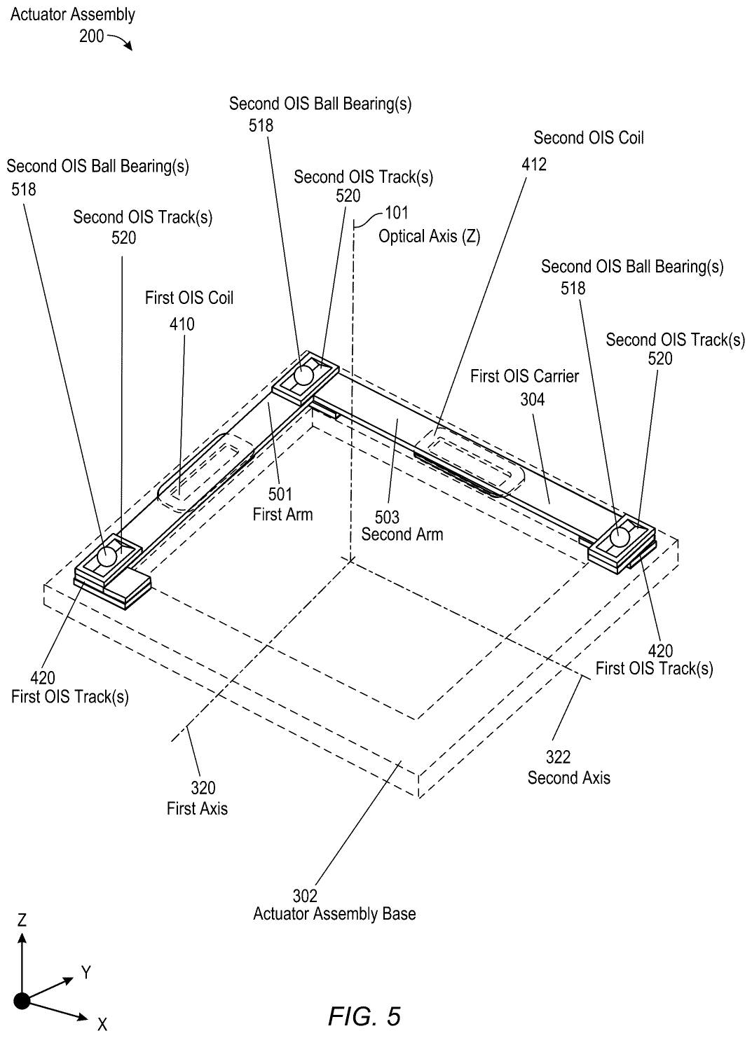

FIG. 5 illustrates components of an example actuator assembly base 302 and a first OIS carrier 304 of an actuator module or assembly 200 that may, for example, be used to provide AF and OIS through lens movement in small form factor cameras, according to at least some embodiments. FIG. 5 shows a perspective view of an actuator assembly base 302 and a first OIS carrier 304 of an actuator module or assembly 200. The actuator assembly base 302, the first OIS carrier 304, and the actuator assembly 200 may include one or more same or similar features as the features described with respect to or illustrated in FIGS. 1, 2, 3, 4, 6, 7, 8, 9, 10, 11, and 12. The example X-Y-Z coordinate system shown in FIG. 5 may be used to discuss aspects of components and/or systems, and may apply to embodiments described throughout this disclosure.

As shown in FIG. 5, the actuator assembly 200 includes the actuator assembly base 302 and the first OIS carrier 304. The first OIS carrier 304 includes a first arm 501, a second arm 503 adjacent the first arm 501, second OIS ball bearings 518, and second OIS tracks 520. The first arm 501 of the first OIS carrier 304 may be positioned over the first arm 401 of the actuator assembly base 302 and the second arm 503 of the first OIS carrier 304 may be positioned over the second arm 403 of the actuator assembly base 302. The second OIS ball bearings 518 are positioned in the second OIS tracks 520 located at the end of the first arm 501 of the first OIS carrier 304, at the end of the second arm 503 of the first OIS carrier 304, and where the first arm 501 and the second arm 503 of the OIS carrier 304 meet. The second OIS ball bearings 518 and the second OIS tracks 520 may be vertically aligned with the first OIS ball bearings 418 and the first OIS tracks 420.

The first OIS carrier 304, together with the second OIS carrier 306, is configured to move the optical assembly 103 along both the first axis 320 and the second axis 322 for OIS movement of the optical assembly 103. For example, as described herein, the first OIS carrier 304 may include OIS tracks on an image side of the first OIS carrier 304 that together with the first OIS ball bearings 418 and the first OIS tracks 420 of the actuator assembly base 302 allow motion of the first OIS carrier 304, the second OIS carrier 306, the AF carrier 308 along the first axis 320. Because the optical assembly 103 is fixedly attached to the AF carrier 308, motion of the AF carrier 308 along the first axis 320 allows motion of the optical assembly 103 along the first axis 320. The second OIS ball bearings 518 and the second OIS tracks 520 together with OIS tracks located on an image side of the second OIS carrier 306, allow motion of the second OIS carrier 306 and the AF carrier 308 along the second axis 322. Because the optical assembly 103 is fixedly attached to the AF carrier 308, motion of the AF carrier 308 along the second axis 322 allows motion of the optical assembly 103 along the second axis 322.

Also, as described herein, the first OIS coil 410 positioned on the first arm 401 of the actuator assembly base 302 and below the first arm 501 of the first OIS carrier 304 may be vertically aligned (e.g., along an axis parallel to the optical axis 101) with a first OIS magnet fixedly attached the second OIS carrier 306. Similarly, the second OIS coil 412 positioned on the second arm 403 and below the second arm 503 of the first OIS carrier 304 may be vertically aligned (e.g., along an axis parallel to the optical axis 101) with a second OIS magnet fixedly attached the second OIS carrier 306. The first OIS coil 410 together with the first OIS magnet may be used to move the first OIS carrier 304, the second OIS carrier 306, and the AF carrier 308 along the first axis 320 for OIS movement of the optical assembly 103 in, for example, the y-direction. Similarly, the second OIS coil 412 together with the second OIS magnet may be used to move the second OIS carrier 306 and the AF carrier 308 along the second axis 322 for OIS movement of the optical assembly 103 in, for example, the x-direction.

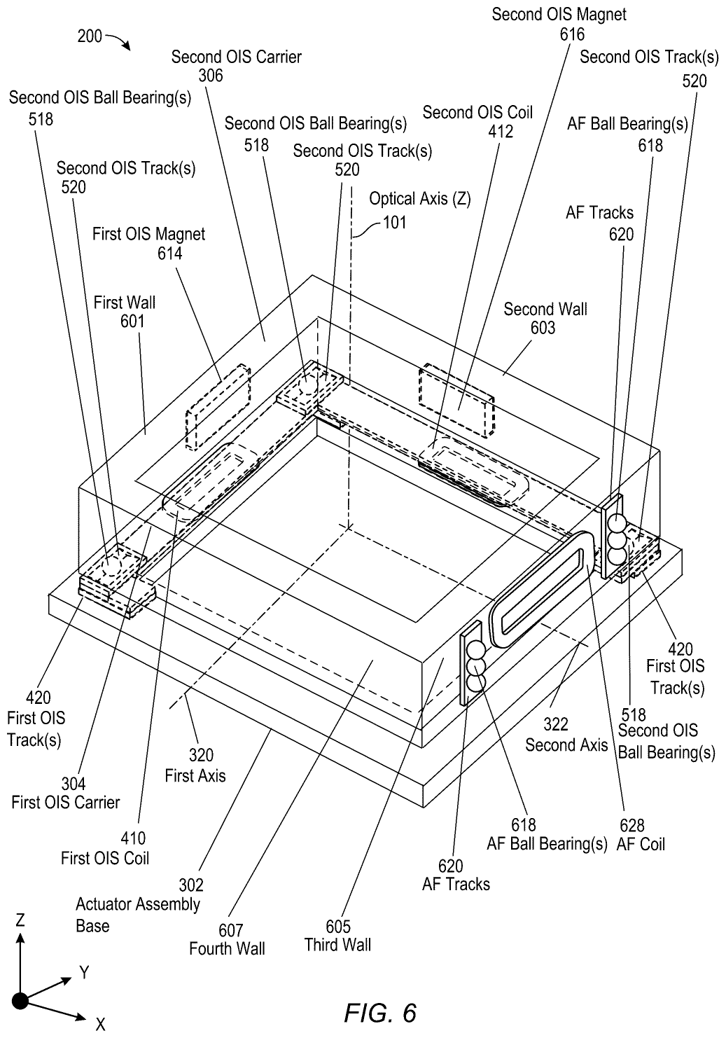

FIG. 6 illustrates components of an example actuator assembly base 302, a first OIS carrier 304, and a second OIS carrier 306 of an actuator module or assembly 200 that may, for example, be used to provide AF and OIS through lens movement in small form factor cameras, according to at least some embodiments. FIG. 6 shows a perspective view of an actuator assembly base 302, a first OIS carrier 304, and a second OIS carrier 306 of an actuator module or assembly 200. The actuator assembly 200 may include one or more same or similar features as the features described with respect to or illustrated in FIGS. 1, 2, 3, 4, 5, 7, 8, 9, 10, 11, and 12. The example X-Y-Z coordinate system shown in FIG. 6 may be used to discuss aspects of components and/or systems, and may apply to embodiments described throughout this disclosure.

As shown in FIG. 6, the actuator assembly 200 includes the actuator assembly base 302, the first OIS carrier 304, and the second OIS carrier 306. The second OIS carrier 306 includes a first wall 601, a second wall 603 adjacent the first wall 601, a third wall 605 that is adjacent the second wall 603 and opposite the first wall 601, and a fourth wall 607 that is adjacent the third wall 605 and the first wall 601 and opposite the second wall 603. The first wall 601 of the second OIS carrier 306 may be positioned over the first arm 401 of the actuator assembly base 302 and the first arm 501 of the first OIS carrier 304. The second wall 603 of the second OIS carrier 306 may be positioned over the second arm 403 of the actuator assembly base 302 and the second arm 503 of the first OIS carrier 304. The third wall 605 of the second OIS carrier 306 may be positioned over the third arm 405 of the actuator assembly base 302. The fourth wall 607 of the second OIS carrier 306 may be positioned over the fourth arm 407 of the actuator assembly base 302.

The second OIS carrier 306 may include OIS tracks positioned in corners of the OIS carrier 306 on the image side surface of the second OIS carrier 306. For example, an OIS track may be positioned on the image side surface of the second OIS carrier 306 where the fourth wall 607 meets the first wall 601, wherein the first wall 601 meets the second wall 603, and where the second wall 603 meets the third wall 605. The OIS tracks formed on the image side surface of the second OIS carrier 306 together with the second OIS tracks 520 may retain the second OIS ball bearings 518 for movement of the second OIS carrier 306, the AF carrier 308, and the optical assembly 103 along the second axis 322 for OIS movement of the optical assembly 103.

The second OIS carrier 306 also includes a first OIS magnet 614 and a second OIS magnet 616. The first OIS magnet 614 may be positioned on and/or within the first wall 601 so that the first OIS magnet 614 is vertically aligned (e.g., in a directional parallel to the optical axis 101) with the first OIS coil 410 positioned on the first arm 401 of the actuator assembly base 302. When the first OIS coil 410 receives electrical current, the magnetic field created by the first OIS magnet 614 creates Lorentz forces to move the first OIS carrier 304, the second OIS carrier 306, the AF carrier 308, and thus the optical assembly 103 along the first axis 320 for OIS movement of the optical assembly 103. Because the first OIS carrier 304 and the second OSI carrier 306 are positioned below the AF carrier and because the first OIS coil 410 is positioned in a flat orientation on the first arm 401 of the actuator assembly base 302, the air gap between the first OIS coil 410 and the first OIS magnet 614 remains constant when the optical assembly 103 moves along each of the first axis 320 for x-direction OIS movement, the second axis 322 for y-direction OIS movement, and the optical axis 101 for z-direction AF movement.

Similarly, the second OIS magnet 616 may be positioned on and/or within the second wall 603 so that the second OIS magnet 616 is vertically aligned (e.g., in a directional parallel to the optical axis 101) with the second OIS coil 412 positioned on the second arm 403 of the actuator assembly base 302. When the second OIS coil 412 receives electrical current, the magnetic field created by the second OIS magnet 616 creates Lorentz forces to move the second OIS carrier 306 and the AF carrier 308, and thus the optical assembly 103 along the second axis 322 for OIS movement of the optical assembly 103. The first OIS carrier 304 positioned below the second OIS carrier 306, the AF carrier 308, and the optical assembly 103 may not move during OIS movement of the optical assembly 103 along the second axis 322. Because first OIS carrier 304 remain static during movement of the optical assembly along the second axis 322, the second OSI carrier 306 is positioned below the AF carrier, and the second OIS coil 412 is positioned in a flat orientation on the second arm 403 of the actuator assembly base 302, the air gap between the second OIS coil 412 and the second OIS magnet 616 remains constant when the optical assembly 103 moves along each of the first axis 320 for x-direction OIS movement, the second axis 322 for y-direction OIS movement, and the optical axis 101 for z-direction AF movement.

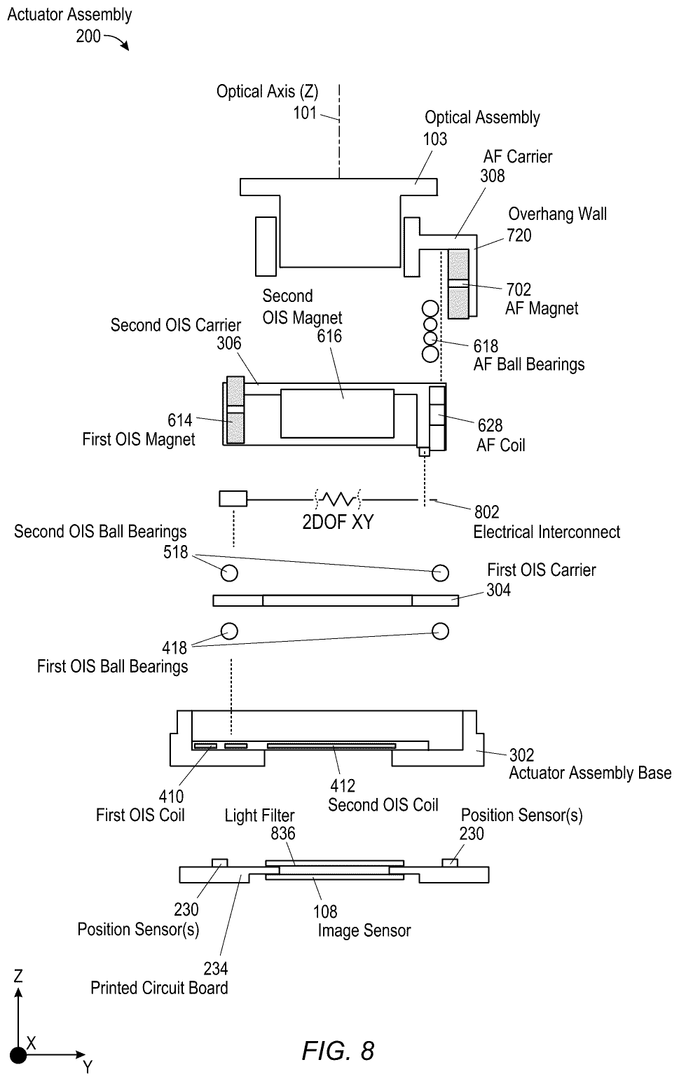

The second OIS carrier 306 also includes an AF coil 628, AF ball bearings 618, and AF tracks 620. The AF coil 628 may be positioned on a surface (e.g., an exterior surface or an interior surface) of the third wall 605 of the second OIS carrier 306 and/or within the third wall 605 of the second OIS carrier 306. As described herein, the AF carrier 308 may include an overhang wall that extends over the third wall 605 of the second OIS carrier 306 and that extend downward (e.g., in a direction parallel to the optical axis 101) along the exterior surface of the third wall 605 of the second OIS carrier 306. An AF magnet positioned on and/or within the overhang wall may align with the AF coil 628 to move the AF carrier 308 and the optical assembly 103 along the optical axis 101 for AF movement of the optical assembly 103. As described herein at least with respect to FIG. 8, an electrical interconnect that may be flexible and extend around and/or through the actuator assembly 200 may electrically connect the AF coil 628 on the moving second OIS carrier 306 with a stationary portion of the actuator assembly 200 (e.g., the actuator assembly base 302) or a stationary component of the camera 100 for providing electrical current to the AF coil 628 for AF movement of the optical assembly 103. In some aspects, the electrical interconnect and another electrical channel or wire may provide an electrical connection between a coil and a driver to provide a specific amount of current to a particular coil of a VCM to actuate the optical assembly 113.

The AF tracks 620 may be formed into an exterior surface of the third wall 605 of the second OIS carrier 306. As described herein, the AF carrier 308 may also include AF tracks that are positioned on a surface of the overhang wall that faces the third wall 605 of the second OIS carrier 306 and that align with the AF tracks 620 of the second OIS carrier 306. The AF tracks on the overhang wall of the AF carrier 308 and the AF tracks 620 of the second OIS carrier 306 may contain the AF ball bearings 618 to allow movement of the AF carrier 308 and the optical assembly 103 along the optical axis 101 for AF movement of the optical assembly 103.

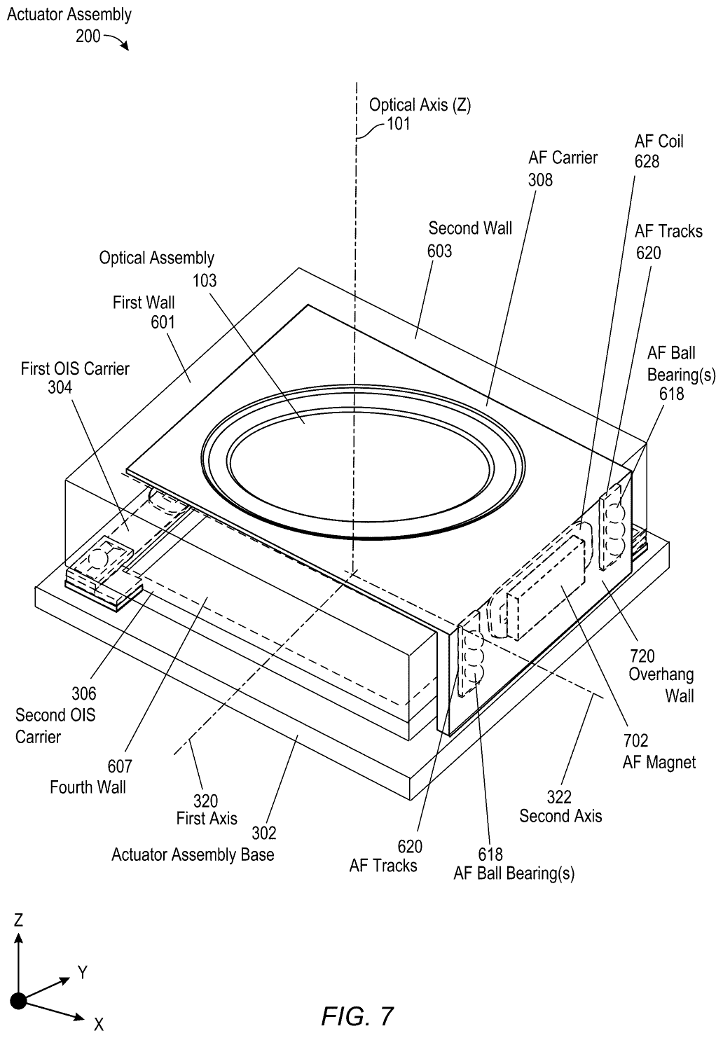

FIG. 7 illustrates components of an example actuator assembly base 302, a first OIS carrier 304, a second OIS carrier 306, and an AF carrier 308 of an actuator module or assembly 200 that may, for example, be used to provide AF and OIS through lens movement in small form factor cameras, according to at least some embodiments. FIG. 7 shows a perspective view of an actuator assembly base 302, a first OIS carrier 304, a second OIS carrier 306, and an AF carrier 308 of an actuator module or assembly 200. The actuator assembly 200 may include one or more same or similar features as the features described with respect to or illustrated in FIGS. 1, 2, 3, 4, 5, 6, 8, 9, 10, 11, and 12. The example X-Y-Z coordinate system shown in FIG. 7 may be used to discuss aspects of components and/or systems, and may apply to embodiments described throughout this disclosure.

As shown in FIG. 7, the actuator assembly 200 includes the actuator assembly base 302, the first OIS carrier 304, the second OIS carrier 306, and the AF carrier 308. The AF carrier 308 and the optical assembly 103 may fixedly attached to one another such that when the AF carrier moves along the first axis 320, the second axis 322, and/or the optical axis 101, the optical assembly 103 also moves along the first axis 320 for OIS movement in the x-direction, the second axis 322 for OIS movement in the y-direction, and/or the optical axis 101 for AF movement in the z-direction, respectively. The optical assembly 103 is position through the AF carrier 308 to allow light to pass through the AF carrier 308 and through openings in the second OIS carrier 306, the first OIS carrier 304, and the actuator assembly base 302 so that light may pass through the lenses of optical assembly 103 and to the image sensor (e.g., the image sensor 108) for capturing an image.

The AF carrier 308 includes an overhang wall 720 having an AF magnet 702. The overhang wall 720 extends over the third wall 605 of the second OIS carrier 306 and extends downward (e.g., in a direction parallel to the optical axis 101) along the exterior surface of the third wall 605 of the second OIS carrier 306. The AF magnet 702 positioned on and/or within the overhang wall 720 may align with the AF coil 628 to move the AF carrier 308 and the optical assembly 103 along the optical axis 101 for AF movement of the optical assembly 103. AF tracks may be positioned on a surface of the overhang wall 720 that faces the third wall 605 of the second OIS carrier 306 and that align with the AF tracks 620 of the second OIS carrier 306. The AF tracks on the overhang wall of the AF carrier 308 and the AF tracks 620 of the second OIS carrier 306 may contain the AF ball bearings 618 to allow movement of the AF carrier 308 and the optical assembly 103 along the optical axis 101 for AF movement of the optical assembly 103.

As described herein, the AF magnet 702 positioned with the overhang wall 720 of the AF carrier 308 may be aligned with AF coil 628. When the AF coil 328 receives electrical current, via the electrical interconnect, the magnetic field created by the AF magnet 702 creates Lorentz forces to move the AF carrier 308, and thus the optical assembly 103 along the optical axis 101. The AF carrier 308 and the optical assembly 103 may move with movement of the second OIS carrier 306 along the first axis 320 and the second axis 322 for OIS movement of the optical assembly 103. Because the AF carrier 308 and the optical assembly 103 may move with movement of the second OIS carrier 306 along the first axis 320 and the second axis 322, the air gap between the AF coil 628 and the AF magnet 702 may remain constant with OIS movement of the optical assembly 103.

In some aspects, the AF carrier 308 may not include an overhang wall 720. Instead the AF magnet 702 may be positioned on the AF carrier 308 such that the AF magnet 702 is located closer to the optical axis compared to the AF coil 628. In such a case, AF ball bearing tracks may be formed on an exterior vertical surface of the AF carrier 308 adjacent the AF magnet 702 and on an interior vertical surface of the second OIS carrier 306 adjacent the AF coil 628 so that ball bearings are retained between the AF carrier 308 and the second OIS carrier 306 for AF movement of the AF carrier 308 and the optical assembly 103.

FIG. 8 illustrates components of an example actuator module or assembly 200 that may, for example, be used to provide AF and OIS through lens movement in small form factor cameras, according to at least some embodiments. FIG. 8 shows an exploded view of the actuator module or assembly 200. The actuator assembly 200 may include one or more same or similar features as the features described with respect to or illustrated in FIGS. 1, 2, 3, 4, 5, 6, 7, 9, 10, 11, and 12. The example X-Y-Z coordinate system shown in FIG. 8 may be used to discuss aspects of components and/or systems, and may apply to embodiments described throughout this disclosure.

As shown in FIG. 8, that actuator assembly 200 may be positioned over a light filter 836 and an image sensor 108 both attached to a printed circuit board (PCB) 234. Position sensors 230 may be aligned with first OIS coil 410 and the second OIS coil 412 located on the actuator assembly base 302 and aligned with the AF magnet 702 on the AF carrier 308 to determine relative positions of the carriers and thus the optical assembly 103 during OIS and AF motion.

The actuator assembly 200 may include the actuator assembly base 302 having the first OIS coils 410 and the second OIS coil 412. As described herein, the first OIS coil 410 and the second OIS coil 412 may be positioned in a flat orientation on the first arm 401 of the actuator assembly base 302 and on the second arm 403 of the actuator assembly base 302, respectively. In other words, a broader side or a side with the greatest surface area of each of the first OIS coil 410 and the second OIS coil 412 may face in a direction parallel to the optical axis 101 and/or in a direction perpendicular to the surface of an image sensor (e.g., image sensor 108 illustrated in FIG. 2) for creating strong Lorentz forces with the first OIS magnet and the second OIS magnet, respectively, to control OIS movement of the optical assembly 103 along the first axis 320 and the second axis 322. The actuator assembly base 302 (as well as the first OIS carrier 904 and the second OIS carrier 908) may include an opening therethrough (e.g., centered on the optical axis 101) to allow light to be received by the image sensor 108 via the lenses of the optical assembly 103.

The first OIS ball bearings 418 may be positioned between the actuator assembly base 302 and the first OIS carrier 304 for OIS movement of the optical assembly 103 along the first axis 320 (e.g., along the x-direction or along the y-direction). Second OIS ball bearings 518 may be positioned between the first OIS carrier 304 and the second OIS carrier 306 for OIS movement of the optical assembly 103 along the second axis 322 (e.g., along the y-direction or along the x-direction). The second OIS carrier 306 may also include the first OIS magnet 614 for interacting with the first OIS coil 410 on the actuator assembly base 302 for moving the optical assembly 103 along the first axis 320 (e.g., along the x-direction or along the y-direction). The second OIS carrier 306 may also include the second OIS magnet 616 for interacting with the second OIS coil 412 on the actuator assembly base 302 for moving the optical assembly 103 along the second axis 322 (e.g., along the y-direction or along the x-direction). In addition, the second OIS carrier 306 may include the AF coil 628 and AF ball bearings 618. The AF coil 628 may interact with the AF magnet 702 positioned on the overhang wall 720 of the AF carrier 308 for providing AF movement of the optical assembly 103. An electrical interconnect 802 that may be flexible and extend around and/or through the actuator assembly 200 may electrically connect the AF coil 628 on the moving second OIS carrier 306 with a stationary portion of the actuator assembly 200 (e.g., the actuator assembly base 302) or a stationary component of the camera 100 for providing electrical current to the AF coil 628 for AF movement of the optical assembly 103.

The AF carrier 308 includes an overhang wall 720 having an AF magnet 702. The overhang wall 720 extends over the third wall 605 of the second OIS carrier 306 and extends downward (e.g., in a direction parallel to the optical axis 101) along the exterior surface of the third wall 605 of the second OIS carrier 306. The AF magnet 702 positioned on and/or within the overhang wall 720 may align with the AF coil 628 to move the AF carrier 308 and the optical assembly 103 along the optical axis 101 for AF movement of the optical assembly 103. AF tracks may be positioned on a surface of the overhang wall 720 that faces the third wall 605 of the second OIS carrier 306 and that align with the AF tracks 620 of the second OIS carrier 306. The AF tracks on the overhang wall 720 of the AF carrier 308 and the AF tracks 620 of the second OIS carrier 306 may contain the AF ball bearings 618 to allow movement of the AF carrier 308 and the optical assembly 103 along the optical axis 101 for AF movement of the optical assembly 103.

As described herein, the AF magnet 702 positioned with the overhang wall 720 of the AF carrier 308 may be aligned with AF coil 628. When the AF coil 328 receives electrical current, via the electrical interconnect, the magnetic field created by the AF magnet 702 creates Lorentz forces to move the AF carrier 308, and thus the optical assembly 103 along the optical axis 101. The AF carrier 308 and the optical assembly 103 may move with movement of the second OIS carrier 306 along the first axis 320 and the second axis 322 for OIS movement of the optical assembly 103. Because the AF carrier 308 and the optical assembly 103 may move with movement of the second OIS carrier 306 along the first axis 320 and the second axis 322, the air gap between the AF coil 628 and the AF magnet 702 may remain constant with OIS movement of the optical assembly 103.

The actuator module or assembly 200 may include at least one OIS carrier that is positioned between the actuator assembly base 302 and the AF carrier 308. For instance, as shown in FIG. 8, the actuator assembly 200 may include in a direction from an image sensor 108 to the optical assembly 103 along the optical axis 101: an actuator assembly base 302, a first OIS carrier 304 positioned on and/or over the actuator assembly base 302, a second OIS carrier 306 positioned on and/or over the first OIS carrier 304 and the actuator assembly base 302, and an AF carrier 308 attached to the optical assembly 103 and positioned on and/or over the second OIS carrier 306, the first OIS carrier 304, and the actuator assembly base 302. This configuration and the positioning of the magnets and coils may allow air gaps between all three magnet and coil pairs of the first OIS magnet and coil pair, the second OIS magnet and coil pair, and the AF magnet and coil pair to remain constant with movement of the optical assembly along each of the optical axis, the first axis, and the second axis.

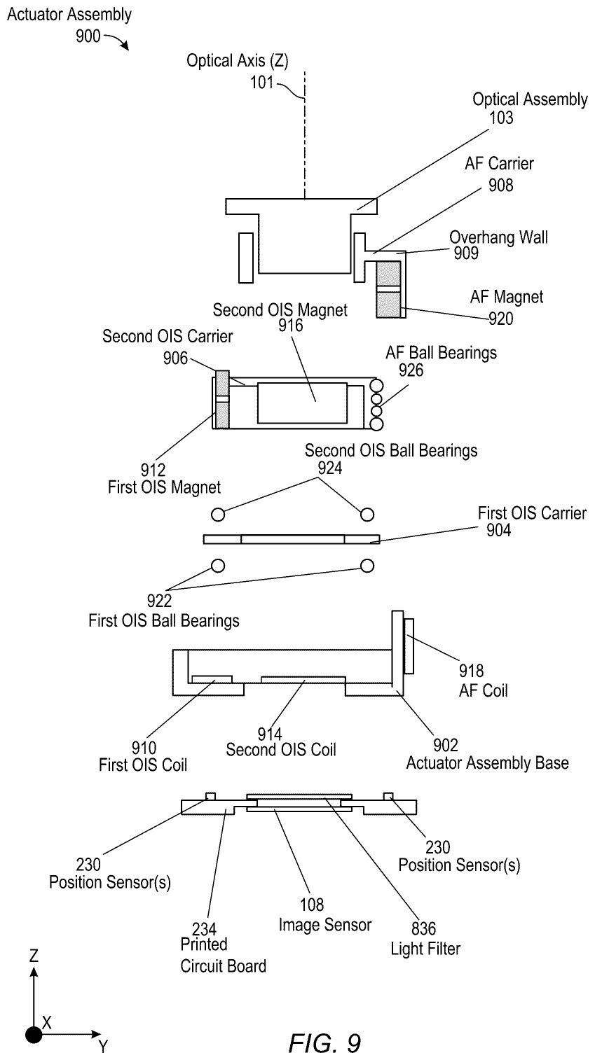

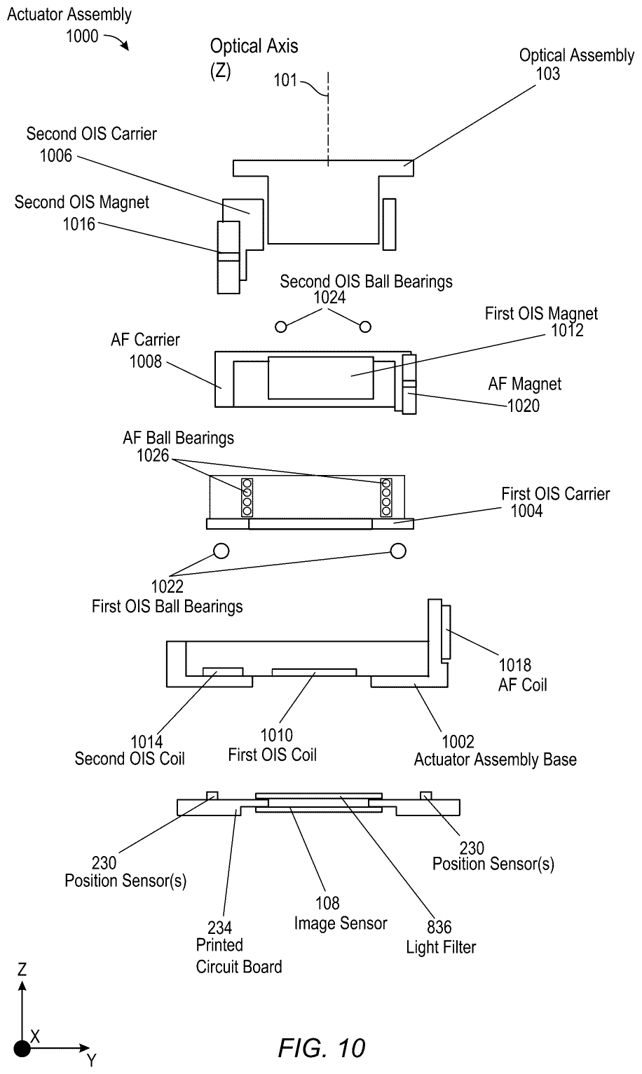

FIGS. 9 and 10 illustrate components of other example actuator modules or assemblies 900 and 1000 that may, for example, be used to provide AF and OIS through lens movement in small form factor cameras, according to at least some embodiments. FIG. 9 shows an exploded view of another actuator module or assembly 900. FIG. 10 shows an exploded view of yet another actuator module or assembly 1000. The actuator assemblies 900 and 1000 may include one or more same or similar features as the features described with respect to or illustrated in FIGS. 1, 2, 3, 4, 5, 6, 7, 8, 11, and 12. The example X-Y-Z coordinate system shown in FIGS. 9 and 10 may be used to discuss aspects of components and/or systems, and may apply to embodiments described throughout this disclosure.

As shown in FIG. 9, the actuator assembly 900 may include the same or similar features as the actuator assembly 200 of FIGS. 3 through 8. The actuator assembly 900 may include the actuator assembly base 902 having the first OIS coils 910 and the second OIS coil 912. The first OIS coil 910 and the second OIS coil 912 may be positioned in a flat orientation on the first arm 401 of the actuator assembly base 902 and on the second arm 403 of the actuator assembly base 902, respectively. In other words, a broader side or a side with the greatest surface area of each of the first OIS coil 910 and the second OIS coil 912 may face in a direction parallel to the optical axis 101 and/or in a direction perpendicular to the surface of an image sensor (e.g., image sensor 108) for creating strong Lorentz forces with the first OIS magnet 912 and the second OIS magnet 916, respectively, to control OIS movement of the optical assembly 103 along the first axis 320 and the second axis 322. The actuator assembly base 902 (as well as the first OIS carrier 904 and the second OIS carrier 908) may include an opening therethrough (e.g., centered on the optical axis 101) to allow light to be received by the image sensor 108 via the lenses of the optical assembly 103.

In addition, instead of the AF coil being position on the second OIS carrier 906, the actuator assembly base 902 may include a vertical wall having an AF coil 918 positioned thereon. As described herein, the AF coil 918 when receiving electrical current may interact with the AF magnet 920 positioned on the AF carrier 908 to generate Lorentz forces for moving the AF carrier 908 and the optical assembly 103 along the optical axis 101.

The first OIS ball bearings 922 may be positioned between the actuator assembly base 902 and the first OIS carrier 904 for OIS movement of the optical assembly 103 along the first axis 320. Second OIS ball bearings 924 may be positioned between the first OIS carrier 904 and the second OIS carrier 906 for OIS movement of the optical assembly 103 along the second axis 322. The second OIS carrier 906 may also include the first OIS magnet 912 for interacting with the first OIS coil 910 on the actuator assembly base 902 for moving the optical assembly 103 along the first axis 320. The second OIS carrier 906 may also include the second OIS magnet 916 for interacting with the second OIS coil 914 on the actuator assembly base 902 for moving the optical assembly 103 along the second axis 322. Because the first OIS carrier 904 and the second OIS carrier 906 are positioned directly above the actuator assembly base 902 (e.g., such that the AF carrier is not positioned below or in between the firs OIS carrier 902 and the second OIS carrier 904), the air gap between the first OIS coil 910 and the first OIS magnet 912 may remain constant. Similarly, because the first OIS carrier 904 and the second OIS carrier 906 are positioned directly above the actuator assembly base 902 (e.g., such that the AF carrier is not positioned below or in between the firs OIS carrier 902 and the second OIS carrier 904), the air gap between the second OIS coil 914 and the second OIS magnet 916 may remain constant.

The AF carrier 308 includes an overhang wall 909 having an AF magnet 920. The overhang wall 909 extends over the third wall 605 of the second OIS carrier 906 and extends downward (e.g., in a direction parallel to the optical axis 101) along the exterior surface of a wall of the second OIS carrier 906 until the AF magnet 920 is positioned adjacent the AF coil 918 on the actuator assembly base 902. The AF magnet 920 positioned on and/or within the overhang wall 909 may align with the AF coil 918 to move the AF carrier 908 and the optical assembly 103 along the optical axis 101 for AF movement of the optical assembly 103. AF tracks may be positioned on a surface of the overhang wall 909 that faces the third wall 605 of the second OIS carrier 906 and that aligns with the AF tracks of the second OIS carrier 906. The AF tracks on the overhang wall 909 of the AF carrier 908 and the AF tracks of the second OIS carrier 906 may contain the AF ball bearings 926 to allow movement of the AF carrier 908 and the optical assembly 103 along the optical axis 101 for AF movement of the optical assembly 103.

As described herein, the AF magnet 920 positioned with the overhang wall 909 of the AF carrier 908 may be aligned with AF coil 918 on the actuator assembly base 902. When the AF coil 918 receives electrical current, the magnetic field created by the AF magnet 920 creates Lorentz forces to move the AF carrier 908, and thus the optical assembly 103 along the optical axis 101. The AF carrier 908 and the optical assembly 103 may move with movement of the second OIS carrier 906 along the first axis 320 and the second axis 322 for OIS movement of the optical assembly 103. However, because the AF carrier 908 and the optical assembly 103 may move with movement of the second OIS carrier 906 along the first axis 320 and the second axis 322 while the actuator assembly base 902 remains static in relation to the first OIS carrier 904, the second OIS carrier 906, and the AF carrier 908, the air gap between the AF coil 918 and the AF magnet 920 may still vary with OIS movement of the optical assembly 103.

This configuration and the positioning of the magnets and coils may allow air gaps between at least two magnet and coil pairs of the first OIS magnet and coil pair, the second OIS magnet and coil pair, and the AF magnet and coil pair to remain constant with movement of the optical assembly 103 along each of the optical axis, the first axis, and the second axis.

As shown in FIG. 10, the actuator assembly 1000 may include in a direction from an image sensor 108 to the optical assembly 103 along the optical axis 101: an actuator assembly base 1002, a first OIS carrier 1004 positioned on and/or over the actuator assembly base 1002, an AF carrier 1008 positioned on and/or over the first OIS carrier 1004 and the actuator assembly base 1002, and a second OIS carrier 1006 attached to the optical assembly 103 and positioned on and/or over the AF carrier 1008, the first OIS carrier 1004, and the actuator assembly base 1002.

The actuator assembly 1000 may include the same or similar features as the actuator assembly 200 of FIGS. 3 through 8 as well as the same or similar features as the actuator assembly 900 of FIG. 9. The actuator assembly 1000 may include an actuator assembly base 1002 having first OIS coils 1010 and second OIS coil 1014. The first OIS coil 1010 and the second OIS coil 1014 may be positioned in a flat orientation on the first arm 401 of the actuator assembly base 1002 and on the second arm 403 of the actuator assembly base 1002, respectively. In other words, a broader side or a side with the greatest surface area of each of the first OIS coil 1010 and the second OIS coil 1014 may face in a direction parallel to the optical axis 101 and/or in a direction perpendicular to the surface of an image sensor (e.g., image sensor 108) for creating strong Lorentz forces with the first OIS magnet 1012 and the second OIS magnet 1016, respectively, to control OIS movement of the optical assembly 103 along the first axis 320 and the second axis 322. The actuator assembly base 1002 (as well as the first OIS carrier 1004 and the second OIS carrier 1008) may include an opening therethrough (e.g., centered on the optical axis 101) to allow light to be received by the image sensor 108 via the lenses of the optical assembly 103.

In addition, instead of the AF coil being position on the second OIS carrier 1006, the actuator assembly base 902 may include a vertical wall having an AF coil 1018 positioned thereon. As described herein, the AF coil 1018 when receiving electrical current may interact with the AF magnet 1020 positioned on the AF carrier 1008 to generate Lorentz forces for moving the AF carrier 1008 and the optical assembly 103 along the optical axis 101.

The first OIS ball bearings 1022 may be positioned between the actuator assembly base 1002 and the first OIS carrier 1004 for OIS movement of the optical assembly 103 along the first axis 320. Second OIS ball bearings 1024 may be positioned between the AF carrier 1008 and the second OIS carrier 1006 for OIS movement of the optical assembly 103 along the second axis 322. The AF carrier 1008 may also include the first OIS magnet 1012 for interacting with the first OIS coil 1010 on the actuator assembly base 1002 for moving the optical assembly 103 along the first axis 320. The second OIS carrier 1006 may include the second OIS magnet 1016 for interacting with the second OIS coil 1014 on the actuator assembly base 902 for moving the optical assembly 103 along the second axis 322. Because of the arrangement of the magnets and coils and because the AF carrier 1008 is positioned between the first OIS carrier 1004 and the second OIS carrier 1006 such that the first OIS carrier 1004, the AF carrier 1008, and the second OIS carrier 1006 move in the x-direction (e.g., into and out of the page), the air gap between the first OIS coil 1010 and the first OIS magnet 1012 may remain constant. However, because of the arrangement of the magnets and coils and because the AF carrier 1008 is positioned between the first OIS carrier 1004 and the second OIS carrier 1006 such that movement of the AF carrier 1008 along the optical axis 101 causes movement of the second OIS carrier 1006 along the optical axis 101, the air gap between the second OIS coil 1014 and the second OIS magnet 1016 may vary as the AF carrier 1008 moves along the optical axis 101 for AF.

The AF carrier 1008 includes the AF magnet 1020. The AF magnet 920 is positioned adjacent to and aligned with the AF coil 1018 on the actuator assembly base 1002 to move the AF carrier 908 and the optical assembly 103 along the optical axis 101 for AF movement of the optical assembly 103. AF tracks and AF ball bearings 1026 may be positioned on a vertical wall of the first OIS carrier 1004 to allow movement of the AF carrier 1008, the second OIS carrier 1006, and the optical assembly 103. When the AF coil 1018 receives electrical current, the magnetic field created by the AF magnet 1020 creates Lorentz forces to move the AF carrier 1008, and thus the second OIS carrier 1006 and the optical assembly 103 along the optical axis 101. Because of the arrangement of the magnets and coils and because of the arrangement of the first OIS carrier 1002 such that the first OIS carrier 1004, the AF carrier 1008, and the second OIS carrier 1006 move in the x-direction (e.g., into and out of the page) and OIS movement of the second OIS carrier 1006 in the y-direction (e.g., left and right across the page) does not cause movement of the AF carrier 1008 and the actuator assembly base 1002, the air gap between the AF magnet 1020 and the AF coil 1018 remains constant.

This configuration and arrangement may allow air gaps between at least two magnet and coil pairs of a first OIS magnet and coil pair, a second OIS magnet and coil pair, and an AF magnet and coil pair to remain constant with movement of the optical assembly 103 along each of the optical axis, the first axis, and the second axis.

It should be understood that for ball bearings and associated tracks, pre-load plates positioned on a side of a coil opposite a magnet may be used to retain the ball bearings in the associated tracks. For example, with respect to the actuator assembly 200, the second OIS carrier 306 may include a pre-load in the third wall 605 adjacent the AF coil 628 and on a side of the AF coil 628 that is away from the AF magnet 702. The magnetic attraction of the pre-load plate towards the AF magnet 702 forces the AF ball bearings 618 and the AF tracks 620 towards the AF tracks on the overhang wall 720 securing the AF ball bearings 618 into the tracks for AF movement of the AF carrier 308 and the optical assembly 103.

It should be understood that in some embodiments, the first OIS magnet (e.g., the first OIS magnet 614), the second OIS magnet (e.g., the second OIS magnet 616), and the AF magnet (e.g., the AF magnet 720) may dual-pole magnets. Dual-pole magnets include a pair of magnets positioned against each other such that a positive end of one magnet is adjacent a negative end of the other magnet at each end of the dual-pole magnet pair. This configuration creates a smaller (e.g., a potentially more concentrated) magnetic field so that a coil adjacent the dual-pole magnet is in range of the magnetic field while other objects (e.g., including other VCM) that are near the dual-pole magnet are out of range of the dual-pole magnet's magnetic field. As such, dual-pole magnetics reduce interference between adjacent or near VCM actuators (e.g., of nearby camera modules) and other components of the actuator assembly and camera.

FIG. 11 illustrates a schematic representation of an example device 1100 that may include a camera (e.g., as described herein with respect to FIGS. 1, 2, 3, 4, 5, 6, 7, 8, 9, 10, and 12), in accordance with some embodiments. In some embodiments, the device 1100 may be a mobile device and/or a multifunction device. In various embodiments, the device 1100 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 1100 may include a display system 1102 (e.g., comprising a display and/or a touch-sensitive surface) and/or one or more cameras 1104. In some non-limiting embodiments, the display system 1102 and/or one or more front-facing cameras 1104a may be provided at a front side of the device 1100, e.g., as indicated in FIG. 11. Additionally, or alternatively, one or more rear-facing cameras 1104b may be provided at a rear side of the device 1100. In some embodiments comprising multiple cameras 1104, some or all of the cameras may be the same as, or similar to, each other. Additionally, or alternatively, some or all of the cameras may be different from each other. In various embodiments, the location(s) and/or arrangement(s) of the camera(s) 1104 may be different than those indicated in FIG. 11.

Among other things, the device 1100 may include memory 1106 (e.g., comprising an operating system 1108 and/or application(s)/program instructions 1110), one or more processors and/or controllers 1112 (e.g., comprising CPU(s), memory controller(s), display controller(s), and/or camera controller(s), etc.), and/or one or more sensors 1116 (e.g., orientation sensor(s), proximity sensor(s), and/or position sensor(s), etc.). In some embodiments, the device 1100 may communicate with one or more other devices and/or services, such as computing device(s) 1118, cloud service(s) 1120, etc., via one or more networks 1122. For example, the device 1100 may include a network interface (e.g., network interface 1110) that enables the device 1100 to transmit data to, and receive data from, the network(s) 1122. Additionally, or alternatively, the device 1100 may be capable of communicating with other devices via wireless communication using any of a variety of communications standards, protocols, and/or technologies.

FIG. 12 illustrates a schematic block diagram of an example computing device, referred to as computer system 1200, that may include or host embodiments of a camera (e.g., as described herein with respect to FIGS. 1, 2, 3, 4, 5, 6, 7, 8, 9, 10, and 11). In addition, computer system 1200 may implement methods for controlling operations of the camera and/or for performing image processing images captured with the camera. In some embodiments, the device 1200 (described herein with reference to FIG. 12) may additionally, or alternatively, include some or all of the functional components of the computer system 1200 described herein.

The computer system 1200 may be configured to execute any or all of the embodiments described above. In different embodiments, computer system 1200 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1200 includes one or more processors 1202 coupled to a system memory 1204 via an input/output (I/O) interface 1206. Computer system 1200 further includes one or more cameras 1208 coupled to the I/O interface 1206. Computer system 1200 further includes a network interface 1210 coupled to I/O interface 1206, and one or more input/output devices 1212, such as cursor control device 1214, keyboard 1216, and display(s) 1218. In some cases, it is contemplated that embodiments may be implemented using a single instance of computer system 1200, while in other embodiments multiple such systems, or multiple nodes making up computer system 1200, may be configured to host different portions or instances of embodiments. For example, in one embodiment some elements may be implemented via one or more nodes of computer system 1200 that are distinct from those nodes implementing other elements.

In various embodiments, computer system 1200 may be a uniprocessor system including one processor 1202, or a multiprocessor system including several processors 1202 (e.g., two, four, eight, or another suitable number). Processors 1202 may be any suitable processor capable of executing instructions. For example, in various embodiments processors 1202 may be general-purpose or embedded processors implementing any of a variety of instruction set architectures (ISAs), such as the x86, PowerPC, SPARC, or MIPS ISAs, or any other suitable ISA. In multiprocessor systems, each of processors 1202 may commonly, but not necessarily, implement the same ISA.

System memory 1204 may be configured to store program instructions 1220 accessible by processor 1202. In various embodiments, system memory 1204 may be implemented using any suitable memory technology, such as static random access memory (SRAM), synchronous dynamic RAM (SDRAM), nonvolatile/Flash-type memory, or any other type of memory. Additionally, existing camera control data 1222 of memory 1204 may include any of the information or data structures described above. In some embodiments, program instructions 1220 and/or data 1222 may be received, sent or stored upon different types of computer-accessible media or on similar media separate from system memory 1204 or computer system 1200. In various embodiments, some or all of the functionality described herein may be implemented via such a computer system 1200.

In one embodiment, I/O interface 1206 may be configured to coordinate I/O traffic between processor 1202, system memory 1204, and any peripheral devices in the device, including network interface 1210 or other peripheral interfaces, such as input/output devices 1212. In some embodiments, I/O interface 1206 may perform any necessary protocol, timing or other data transformations to convert data signals from one component (e.g., system memory 1204) into a format suitable for use by another component (e.g., processor 1202). In some embodiments, I/O interface 1206 may include support for devices attached through various types of peripheral buses, such as a variant of the Peripheral Component Interconnect (PCI) bus standard or the Universal Serial Bus (USB) standard, for example. In some embodiments, the function of I/O interface 1206 may be split into two or more separate components, such as a north bridge and a south bridge, for example. Also, in some embodiments some or all of the functionality of I/O interface 1206, such as an interface to system memory 1204, may be incorporated directly into processor 1202.

Network interface 1210 may be configured to allow data to be exchanged between computer system 1200 and other devices attached to a network 1224 (e.g., carrier or agent devices) or between nodes of computer system 1200. Network 1224 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1210 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1212 may, in some embodiments, include one or more display terminals, keyboards, keypads, touchpads, scanning devices, voice or optical recognition devices, or any other devices suitable for entering or accessing data by one or more computer systems 1200. Multiple input/output devices 1212 may be present in computer system 1200 or may be distributed on various nodes of computer system 1200. In some embodiments, similar input/output devices may be separate from computer system 1200 and may interact with one or more nodes of computer system 1200 through a wired or wireless connection, such as over network interface 1210.

Those skilled in the art will appreciate that computer system 1200 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1200 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical assembly having one or more lenses defining an optical axis;
an actuator assembly, wherein the actuator assembly comprises:
a plurality of carriers, wherein respective carriers of the plurality of carriers are configured to allow movement of the optical assembly along respective axes of the optical axis, a first axis orthogonal to the optical axis, and a second axis orthogonal to the first axis and the optical axis;
a plurality of ball bearings for the respective carriers, wherein respective ball bearings of the plurality of ball bearings are for allowing movement along the respective axes; and
a plurality of actuators, wherein respective actuators of the plurality of actuators are configured to move the optical assembly, via the respective carriers, along the respective axes in response to receiving electrical current, wherein coils of at least two of the plurality of actuators for movement of the optical assembly along at least two axes of the respective axes face in a direction parallel to the optical axis, and wherein respective gaps between magnets and associated coils of at least two of the plurality of actuators for movement of the optical assembly along at least two axes of the respective axes remain constant during movement of the optical assembly along each of the optical axis, the first axis, and the second axis.

2. The camera of claim 1, wherein the plurality of carriers comprises at least a first optical image stabilization (OIS) carrier, a second OIS carrier, and an autofocus (AF) carrier that are arranged in a stacked configuration along the optical axis.

3. The camera of claim 2, wherein the AF carrier is fixedly attached to the optical assembly, and wherein the second OIS carrier is positioned between the AF carrier and the first OIS carrier along the optical axis.

4. The camera of claim 3, wherein the plurality of actuators comprises a first OIS actuator, a second OIS actuator, and an AF actuator, and wherein a coil of the AF actuator is positioned on the second OIS carrier.

5. The camera of claim 3, further comprising a base positioned on an image side of the plurality of carriers, wherein the plurality of actuators comprises a first OIS actuator, a second OIS actuator, and an AF actuator, and wherein a coil of the AF actuator is positioned on a wall of the base.

6. The camera of claim 2, wherein the first OIS carrier is attached to the optical assembly, and wherein the AF carrier is positioned between the first OIS carrier and the second OIS carrier along the optical axis.

7. The camera of claim 6, further comprising a base positioned on an image side of the plurality of carriers, wherein the plurality of actuators comprises a first OIS actuator, a second OIS actuator, and an AF actuator, and wherein a coil of the AF actuator is positioned on a wall of the base.

8. A device, comprising:
one or more processors;
memory storing program instructions executable by the one or more processors to control operation of a camera; and
the camera comprising:
an optical assembly having one or more lenses defining an optical axis;
an actuator assembly, wherein the actuator assembly comprises:
a plurality of carriers, wherein respective carriers of the plurality of carriers are configured to allow movement of the optical assembly along respective axes of the optical axis, a first axis orthogonal to the optical axis, and a second axis orthogonal to the first axis and the optical axis;
a plurality of ball bearings for the respective carriers, wherein respective ball bearings of the plurality of ball bearings are for allowing movement along the respective axes; and
a plurality of actuators, wherein respective actuators of the plurality of actuators are configured to move the optical assembly, via the respective carriers, along the respective axes in response to receiving electrical current, wherein coils of at least two of the plurality of actuators for movement of the optical assembly along at least two axes of the respective axes face in a direction parallel to the optical axis, and wherein respective gaps between magnets and associated coils of at least two of the plurality of actuators for movement of the optical assembly along at least two axes of the respective axes remain constant during movement of the optical assembly along each of the optical axis, the first axis, and the second axis.

9. The device of claim 8, further comprising a base positioned on an image side of the plurality of carriers, wherein the coils of the at least two of the plurality of actuators for movement of the optical assembly along the at least two axes of the respective axes and that face in the direction parallel to the optical axis are positioned on a seat of the base.

10. The device of claim 8, wherein the plurality of carriers comprises at least a first optical image stabilization (OIS) carrier, a second OIS carrier, and an autofocus (AF) carrier that are arranged in a stacked configuration along the optical axis.

11. The device of claim 10, wherein the AF carrier is fixedly attached to the optical assembly, and wherein the second OIS carrier is positioned between the AF carrier and the first OIS carrier along the optical axis.

12. The device of claim 11, wherein the plurality of actuators comprises a first OIS actuator, a second OIS actuator, and an AF actuator, and wherein a coil of the AF actuator is positioned on the second OIS carrier.

13. The device of claim 10, wherein the plurality of OIS actuators comprises at least one magnet, and wherein the at least one magnet of the plurality of OIS actuators is fixedly attached to the second carrier and is vertically aligned with the at least one coil of the plurality of OIS actuators.

14. The device of claim 10, wherein the first OIS carrier, the second OIS carrier and the AF carrier are arranged in a stacked configuration along the optical axis, wherein the AF carrier is fixed attached to the optical assembly, wherein the second OIS carrier is positioned between the AF carrier and the first OIS assembly along the optical axis.

15. An actuator assembly, comprising:
a plurality of carriers, wherein respective carriers of the plurality of carriers are configured to allow movement of an optical assembly along respective axes of the optical axis, a first axis orthogonal to the optical axis, and a second axis orthogonal to the first axis and the optical axis;
a plurality of ball bearings for the respective carriers, wherein respective ball bearings of the plurality of ball bearings are for allowing movement along the respective axes; and
a plurality of actuators, wherein respective actuators of the plurality of actuators are configured to move the optical assembly, via the respective carriers, along the respective axes in response to receiving electrical current, wherein coils of at least two of the plurality of actuators for movement of the optical assembly along at least two axes of the respective axes face in a direction parallel to the optical axis, and wherein respective gaps between magnets and associated coils of at least two of the plurality of actuators for movement of the optical assembly along at least two axes remain constant during movement of the optical assembly along each of the optical axis, the first axis, and the second axis.

16. The actuator assembly of claim 15, wherein the plurality of carriers comprises at least a first optical image stabilization (OIS) carrier, a second OIS carrier, and an autofocus (AF) carrier that are arranged in a stacked configuration along the optical axis.

17. The actuator assembly of claim 16, wherein the AF carrier is fixedly attached to the optical assembly, and wherein the second OIS carrier is positioned between the AF carrier and the first OIS carrier along the optical axis.

18. The actuator assembly of claim 17, wherein the plurality of actuators comprises a first OIS actuator, a second OIS actuator, and an AF actuator, and wherein a coil of the AF actuator is positioned on the second OIS carrier.

19. The actuator assembly of claim 17, further comprising a base positioned on an image side of the plurality of carriers, wherein the plurality of actuators comprises a first OIS actuator, a second OIS actuator, and an AF actuator, and wherein a coil of the AF actuator is positioned on a wall of the base.

20. The actuator assembly of claim 15, further comprising an electrical interconnect configured to flex and provide electrical current from a stationary component of a camera and to a coil of an actuator of the plurality of actuators positioned on a moving carrier of the plurality of carriers.
